(19) United States
(12) Patent Application Publication
(10) Pub. No.: US 2003/0178484 A1
(43) Pub. Date: Sep. 25, 2003

(54) Systems and methods for electronic voting

(76) Inventors: Dennis Vadura, Trabuco Canyon, CA (US); Frank J. Wiebe, Laguna Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/392,742

(22) Filed: Mar. 19, 2003

Related U.S. Application Data
(63) Continuation of application No. 10/190,964, filed on Jul. 5, 2002.
(60) Provisional application No. 60/303,476, filed on Jul. 6, 2001.

(51) Int. Cl. G06F 17/60

(52) U.S. Cl. 235/386

(57) ABSTRACT

An electronic voting system has a voting administrative module connected to a plurality of voting modules connected via a network. A voter initiates the voting process by inserting a voting key into a voting key reader of a voting module. The voter then makes voting selections, which include casting votes, on a touch screen display of the voting module. Alternatively, the voting module may verbally guide the voter through the voting process using an audio headphone. The voter may also make voting selections verbally through a microphone using voice recognition technology, or by using a tactile keypad. After the voter is finished casting votes, a voter verifiable paper ballot is printed and an electronic ballot is saved on the electronic voting system. The voter can review the paper ballot. If the voter is not satisfied with the voting selections reflected on the paper ballot, then the paper ballot and the electronic ballot may be spoiled and the voter given a new voting key to use to re-cast the votes on the electronic voting system.

### PRIORITY CLAIM

This application is a continuation of U.S. patent application Ser. No. 10/190,964, filed Jul. 5, 2002, the disclosure of which is incorporated in its entirety herein by reference.

### FIELD OF THE INVENTION

This disclosure generally relates to electronic voting systems and methods, and more particularly, relates to electronic voting systems having features that are user-friendly and that provide accurate and verifiable voting results.

### BACKGROUND OF THE INVENTION

Recent elections have demonstrated the fallibility of the current voting systems and methods. For example, it has been suggested that current punch card voting systems and methods may inaccurately reflect many voters' intentions. While an electronic voting system would improve the accuracy and reliability of voting over the current systems and methods, a specific problem with using an electronic voting system is that many voters are uncomfortable with computers due to a lack of understanding of how computers work. Furthermore, this problem is exacerbated by recent stories about computer hackers and problems caused by computer viruses. Thus, there is a need for a voting system and method that is accurate, secure and easy for the voters to operate.

### SUMMARY OF THE INVENTION

The preferred embodiments of this invention advantageously include several features, which promote the accuracy and reliability of voting and which also promote public confidence by operating within the context of the current voting experience.

These features include the advantages that a voter's selections are kept secret; that each eligible voter may vote only once; and only for those selections for which the voter is entitled to vote; that the tampering of votes is prevented or at least reduced; that buying or selling of votes is not facilitated by the voting system; that all votes are reported accurately; that the voting system remains available and operable during the voting period authorized for the election; and that an audit trail is kept to ensure that the above-described advantages are met and that each voter's selections are kept secret.

The electronic voting systems of the present invention provide for a confidential, secure, accurate, auditable, reliable and immediate solution for voting at an official polling site. A preferred embodiment of the electronic voting system comprises one or more voting modules connected to a voting administrative module. The voting modules and voting administrative module are advantageously located at manned election polling sites. The voting administrative module may optionally be connected to a central polling site for conveying voting information to the central polling site. However, the polling site electronic voting system may also be used without being connected to the central polling site for advantageously reducing the likelihood of external tampering.

One aspect of the present invention is a method and apparatus for voting that produces an official voter verifiable paper ballot. The method and apparatus includes a voting administrative module that has a first network interface capable of connectivity to a network. The voting administrative module is then capable of sending and receiving voting information over the network and electronically tallying and storing the voting information. The method and apparatus also includes at least one voting module that has a second network interface for connectivity to the network. The voting module is capable of receiving votes cast by a voter and sending voting information to the voting administrative module. The voting module includes a processor for analyzing voting information and one or more electronic storage devices for storing voting information. Furthermore, the voting module includes a voting key reader adapted to receive and analyze a voting key, where the electronic voting system enables a voter to cast votes on the voting system only when the voting key is proper. Additionally, the voting module includes a touch screen display for displaying voting options to a voter and allowing the voter to select the voting options by touching said touch screen display. The electronic voting system also includes at least one printer that has a third network interface for connectivity to the network of voting modules, or it includes a printer that is directly connected to each voting module. The printer is adapted to receive voting information and is capable of printing a ballot that indicates the votes cast by the voter. The printer is also capable of printing the ballot using optical recognition characters and printing a ballot that capable of being reviewed by the voter for verifying the votes.

Another aspect of the present invention is a method and apparatus for electronically voting that generates a voter verifiable paper ballot. The method and apparatus include providing a voting key for enabling a voter to vote on a voting module. The voting key is inserted into a voting key reader of an electronic voting module. The method and apparatus analyzes the voting key to verify that the voter has permission to vote. If the voter has permission to vote, then the method and apparatus displays voting options on a touch screen display of the electronic voting module. The voting options are then selected by touching the touch screen display. The method and apparatus also generates a voter verifiable paper ballot, where the voter verifiable paper ballot includes the selections that the voter has made by touching the touch screen display.

Another aspect of the present invention is a method and apparatus for electronically voting that is easy to shut down at the close of the polling site. The method and apparatus includes a database on the voting administrative module containing a copy of the ballots cast on each voting module at the polling site. At the close of voting, the voting administrative module is shut down. The shut down process of the voting administrative module preferably includes the local election official inserting or entering an administrative key or code into the voting administrative module. The election official then archives the voting administrative module database by inserting a blank write-once media into the voting administrative module media-writer and selecting an archive voting-database button. After the voting administrative module database has been archived, the election official selects a print reports button to print the tallied vote counts for the polling place. After the reports have been printed, a power on/off button is pressed to shut down the voting administrative module.

Another aspect of an electronic voting system is a method and apparatus for facilitating the casting and counting of votes in an election. The method and apparatus include a voting administrative module connected to one or more voting modules. The voting modules have a touch sensitive display screen for displaying screens that enable voters to cast their votes for candidates in election contests. The voting administrative module is connected via a network to one or more voting modules at a polling place. A ballot creation program that constructs the ballots is loaded into the voting modules at each polling place. A standardized database is installed on each voting module and voting administrative module to store the votes for one or more election contests. A voting key is used to initiate the voting process on a voting module. A voting application processes the votes at each voting module. A tally table is stored in the database on the voting module for recording all votes cast on that voting module for each candidate in all election contests. A tally table is also stored in the database on the voting administrative module for recording all votes cast for each candidate in all election contests tallied from the votes cast at all voting modules at the polling place. Furthermore, the method and apparatus include a printer for printing the voter's selections on a physical paper ballot.

Another aspect of the present invention is a method and apparatus having a standard database structure stored in a computer readable medium for facilitating electronic voting and counting. The method and apparatus comprise a table of candidate names and party affiliations, a table of election contests on the ballot, a table linking the election contest to the list of candidates running in the contest, and a table of ballots that contains all ballots cast at the voting module.

Another aspect of the present invention is an electronic voting system that has a ballot table. The electronic voting system stores the ballot table on a computer readable medium. The ballot table contains all of ballots cast on the apparatus. The table includes a unique identifier (ballot key) associated with each ballot cast, an audit timestamp that indicates when ballot was cast, an entry for each contest containing the candidate or candidates that the voter selected in the contest, a SPOILED_BALLOT indicator flag that indicates if the ballot has been spoiled and excluded from the final vote tally and a PROVISIONAL_BALLOT indicator flag that indicates that the ballot should not be counted in the vote tally results until the eligibility of the voter who cast the ballot is confirmed. The electronic voting system includes the ballot as part of the official vote tally once the voter eligibility has been confirmed. The electronic voting system may optionally have the same ballot table format on the voting module and the voting administrative module.

Another aspect of the present invention is a method and apparatus for electronically voting having a tally table. The method and apparatus store the tally table as part of the standardized database on the voting module. The tally table comprises an entry for each election contest, a list of entries for each contest consisting of the candidate name and the number of votes cast for that candidate on the voting module, and a count of the total number of ballots cast at the voting module.

Another aspect of the present invention is a method and apparatus for electronically voting having an Extensible Markup Language (“XML”) Document Type Definition (“DTD”) that defines the ballot for an election. The XML DTD of the method and apparatus comprises a date and name of the election, type of election contest (i.e., general election, primary election), a list of candidate names and party affiliations, an election contest to be included on the ballot, a list of candidates to running in each election contest, a number of selections a voter is permitted to make for each contest, controls for how candidates are to be displayed for each contest, language selections supported by the ballot, a list of screens to be displayed, text that is to be displayed on each screen in all supported languages, active buttons on each screen, the order that screens should be displayed, and an initial screen to display.

Another aspect of the present invention is a method and apparatus for electronically voting that supports a voter casting a ballot. The method and apparatus comprise a computer workstation where a voting application executes. The method and apparatus include a storage medium within the computer workstation where the voter's ballots and the voting application are stored. The method and apparatus have one or more touch sensitive voting display screens connected to the computer workstation that the voter uses to make his or her selections. A voting key reader is connected to the computer workstation, and the voter inserts a voting key into the reader to start the voting process. A printer is connected to the computer workstation to print the voter's selections on a physical paper ballot. The method and apparatus also include a network interface card that connects the computer workstation to the network at the polling site.

Another aspect of the present invention is a method and apparatus for electronically voting having a voting application that executes on the voting modules. The method and apparatus comprises an XML parser that parses XML encoded ballot specifications to generate the screens required for the voting application. The method and apparatus recognize when a voter has inserted a voting key into the voting key reader and checks the voting key to ensure that the voting key is valid and is enabled for the polling place. The method and apparatus provide the voter with a selection of languages from a list of supported languages to use during the voting session and instructional pages to instruct the voter how to use the voting module to cast their ballot. The method and apparatus display a voting page for each contest on the ballot and permits a voter to select from the list of candidates displayed on the touch sensitive display. The method and apparatus also permit a voter to enter the names of one or more write-in candidates for whom the voter wants to vote. The method and apparatus also reduces the risk of over-voting by not allowing the voter to select more candidates than allowed in any given election contest. The method and apparatus inform the voter that the voter has made an insufficient number of selections in the election contest selections if the voter has under-voted in a election contest. The method and apparatus then ask the voter whether the voter wants to continue to the next contest, or return to the current contest page to make additional votes. Also, in election districts where allowed, the method and apparatus permit an optional Not Voting button to be available to the voter to indicate that the voter does not want to cast a vote in a contest. The method and apparatus include a feature of asking the voter to confirm the ballot prior to submitting the ballot so that the voter's intent is not misunderstood. The method and apparatus also allow a voter to move directly to a specific contest page to change the vote from a review ballot page. Furthermore, when the voter is satisfied with the ballot, the voter confirms the ballot, which results in an electronic copy of the ballot being stored on the voting module and the voting administrative module. The method and apparatus print a physical paper ballot and prompts the voter to review the physical ballot prior to depositing the physical ballot into an official ballot box. The method and apparatus also disables the voting key once the voter confirms the ballot. Further, an informational message is sent to the voter to remove the voting key and return it to a polling place election official.

Another aspect of the present invention is a method and apparatus for administering an electronic voting system. The method and apparatus are capable of enabling, disabling and initializing voting keys for different types of elections with ballot logic control information. The method and apparatus print reports at the close of the polling site. The reports include a total number of ballots cast, a total number of ballots cast by ballot type, a total number of spoiled ballots, a total number of provisional ballots, and a total number of ballots cast for each candidate for each contest. The method and apparatus generate a read-only electronic backup of the ballots cast on each of the voting modules supported by or associated with the respective voting administrative module. The method and apparatus also generate a read-only electronic backup of the ballots stored on the voting administrative module and a read-only electronic backup of the audit/error log stored on each voting module and the voting administrative module. The method and apparatus also print a voting administrative module audit report. Further, the method and apparatus is capable a spoiling an electronic copy of a ballot if a voter declares to spoil the paper ballot.

Another aspect of the present invention is a method and apparatus for electronically voting having a ballot creation tool (“BCT”) that administrators use to create the ballot definitions (“ballot types”) for each polling site. XML documents provide the definition of the ballot and its behavior for an election. The XML documents are loaded onto the voting administrative module. The method and apparatus have information specified in the XML documents. The information includes a name and a date of election, a precinct identifier, an election type, a list of partisan and non-partisan contests, a list of languages supported, a list of political parties, a list of candidates for each contest, a ballot logic information (e.g. an order in which contests are to be displayed, instructional and warning/error screens, and straight-party voting indicator), and rules controlling which partisan contests on a primary ballot in which voter can vote depending on whether the voter is registered with a specific political party or registered as an independent. As part of a pre-election day setup, the ballot definitions are downloaded from the voting administrative module to each of the voting modules associated with the voting administrative module in the polling place.

Another aspect of the present invention is a method and apparatus for electronically voting having a physical paper ballot printed in human readable and machine-readable form. Optionally, the ballot may advantageously use OCR characters so that the ballot can be scanned at a later date, if needed.

Another aspect of the present invention is a method and apparatus for electronically voting. The method and apparatus include a feature where a ballot can be spoiled. The method and apparatus allow voters to cast ballots and have a physical paper ballot printed using a computerized voting module. In accordance with the method and apparatus, a voter inserts a voting key to begin the voting process. The voter is then presented with a list of election contests in which the voter is entitled to vote. Each contest has one or more candidates or choices from which the voter selects choices. Once the voter is satisfied with the voting selections, the voter confirms the ballot, which results in the ballot being stored electronically in multiple locations and also results in a paper ballot being printed that includes the voter's selections for each contest. The correlating electronic and paper versions of the ballots have a unique, preferably anonymous, ballot key assigned to the ballot after the voter confirms the ballot. The ballot key is stored on the voting key. The voter then reviews the ballot, and, if the voter is satisfied with the ballot, then the paper ballot is deposited in the official ballot box at the polling site. If the voter is not satisfied with the paper ballot, then the voter returns the used voting key and the paper ballot to an election official at the polling site. The voter then receives a new voting key to re-cast the ballot. The method and apparatus mark the paper ballot as spoiled and set-aside. Using the ballot key stored on the voter's used voting key, an election official extracts the voter's ballot from the database of ballots on the voting administrative station and marks the electronic ballot as spoiled to match the paper ballot.

Another aspect of the present invention is a method and apparatus for electronically voting having features that promote voting by disabled persons (e.g., the blind and paralyzed persons). The method and apparatus include the use of audio headphones to enable the voting module to verbally read the ballot and the voter's ballot selections to the voter. The method and apparatus use the microphone and voice recognition or an external tactile keypad for the voter to make ballot selections and to navigate the ballot. Also, the method and apparatus have a touch screen mounted in compliance with the Americans with Disabilities Act that allows wheelchair bound paraplegic voters to touch the touch screen to cast their ballot.

Another aspect of the present invention is a method and apparatus for electronically voting that include a feature that promotes voting by color-blind persons. For example, a button is provided on the touch screen of the voting module. When the voter touches the color-blind button, the touch screen display changes the colors used to display the ballot to improve legibility to a color-blind voter.

Another aspect of the present invention is a method and apparatus for electronically voting having a language switch button. When touched, the language switch button cycles through the list of available languages programmed for the ballot. The method and apparatus include the language selection button on every screen throughout the voting process.

Another aspect of the present invention is a method and apparatus for electronically voting having a voting key. The voting key of the method and apparatus provides features that permit a voter to vote once and only once using the voting key, does not identify the voter, provides ballot logic control information to the voting module application, acts as a security mechanism by ensuring that the voting key is being used in the proper polling place, indicates if the ballot cast by the voter should be flagged as a provisional ballot, includes a political party identifier for use in primary elections, and includes a storage area where the voting module application can write a ballot key associated with the ballot just cast by the voter.

For purposes of summarizing the invention, certain aspects, advantages and novel features of the invention have been described herein above. It is to be understood, however, that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The preferred embodiments of the present invention will be described below in connection with the attached drawings in which:

FIG. 1 depicts a first architecture of a preferred embodiment of the electronic voting system including a voting administrative module and voting modules electronically coupled to a network;

FIG. 2 is a block diagram of components used in the first architecture of a preferred embodiment of the electronic voting system;

FIG. 3 depicts a second architecture of a preferred embodiment of the electronic voting system including a voting administrative module, voting modules and printers electronically coupled to a network;

FIG. 4 illustrates a flow diagram of a general voting process using a preferred embodiment of the electronic voting system; and

FIGS. 5A-5F illustrate a flow diagram of a portion of the flow diagram illustrated in FIG. 4.

### DETAILED DESCRIPTION OF THE PREFERRED EMBODIMENT

Although certain preferred embodiments and examples are disclosed below, it will be understood by those skilled in the art that the invention extends beyond the specifically disclosed embodiments to other alternative embodiments and/or uses of the invention and obvious modifications and equivalents thereof. Thus, it is intended that the scope of the invention herein disclosed should not be limited by the particular disclosed embodiments described herein.

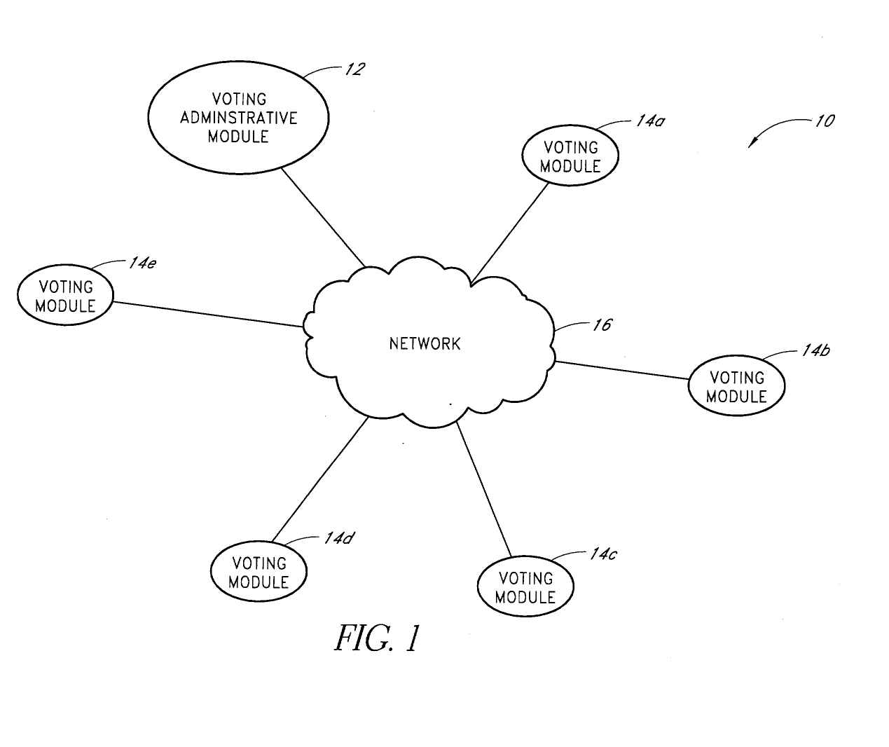

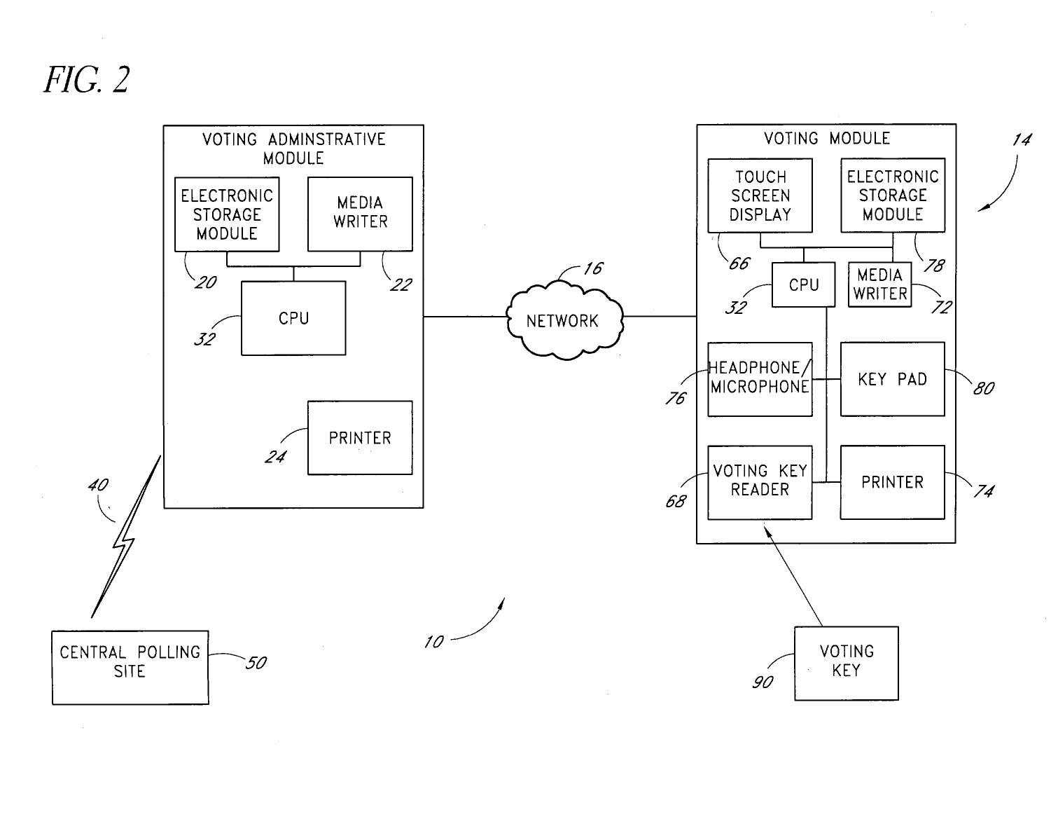

FIGS. 1-2 illustrate a preferred embodiment of the electronic voting system 10. More specifically, as shown in FIG. 1, the electronic voting system 10 nominally includes a voting administrative module 12 and a plurality of voting modules 14 (e.g., 14a, 14b, 14c, 14d, 14e) connected to a network 16. As illustrated, in one embodiment, the voting administrative module 12 and the plurality of voting modules 14 communicate through the network 16. Preferably, the voting administrative module 12 is configured to support (i.e., operate with) one to twenty voting modules 14. Most preferably, the voting administrative module 12 supports one to four voting modules 14. However, the voting administrative module 12 may advantageously be configured to support as many voting modules 14 as desired. Additionally, in alternative architectures, more than one voting administrative module 12 may be used to support the voting modules 14.

FIG. 2 depicts a block diagram of the preferred embodiment of the electronic voting system 10. Generally, the electronic voting system 10 comprises the voting administrative module 12 supporting at least one voting module 14 via the network 16. The network may be, for example, an Ethernet local area network (“LAN”). Other devises may also be advantageously connected to the network 16 such as, for example, a printer 24.

Optionally, the voting administrative module 12 is also capable of communicating voting information with a central polling site 50 over a communication path 40. The voting administrative module 12 communicates with the central polling site 50 via, for example, an analog modem, a cellular modem or an Ethernet LAN connection.

The voting administrative module 12 includes a central processing unit (“CPU”) 32, an electronic storage module 20, a media writer 22 and a printer 24. The central processing unit 32 comprises any device capable of executing computer instructions, such as a computer or a computer server. For example, in one embodiment, the central processing unit 32 may be an IBM ThinkPad T20 laptop computer. The media writer 22 may be a compact disk read and write drive that allows for electronic copies of election results to be created on a removable storage media, such as a write once/ read only compact disk (“CD-R”) or a removable flash memory module. The printer 24 comprises any device capable of storing information in a fixed form, such as a paper print-out. For example, the printer 24 may be, the Lexmark Z55 Ink Jet printer utilized for printing, for example, tally reports and paper ballots.

The voting module 14 includes a central processing unit 62, a touch sensitive display screen 66, a voting key reader 68, a ballot printer 74, an audio headphone/microphone jack 76, a media writer 72, one or more electronic storage modules 78 and an external tactile keypad 80. The central processing unit 62 may be any device capable of executing computer instructions, for example, a PC-on a board that is commercially available as an Intel-based or Transmeta-based single-board computer. The touch sensitive display screen 66 comprises a device capable of displaying computer information while also being capable of receiving input by the touch of the user of the touch sensitive display screen 66. The touch sensitive display screen 66 may be, for example, the Elo Touchsystems Entuitive 1525L. The voting key reader 68 may be, for example, the Axiohm American Magnetics C171A smart card reader. The printer ballot printer 74 may be, for example, the Lexmark Z55 Ink Jet printer. Additionally, each display screen 66 is preferably connected to a dedicated video card (not shown) installed in the respective voting module 14.

Preferably, one ballot printer 74 is dedicated to each voting module 14. In another embodiment, one ballot printer 74 is dedicated to more than one voting module 14. In one embodiment, the ballot printer 74 is directly connected to the same voting module 14 as the display screen 66 using, for example, a standard parallel port interface. In another embodiment, the ballot printer 74 is connected to the voting module 14 through a network interface. The ballot printer 74 is capable of printing a voter verifiable paper ballot that reflects the voter's voting intent. The ballot generated by the ballot printer 74 is advantageously human-readable and uses optical recognition characters so that the ballot is also capable of being read by a computing device, such as through an optical scan.

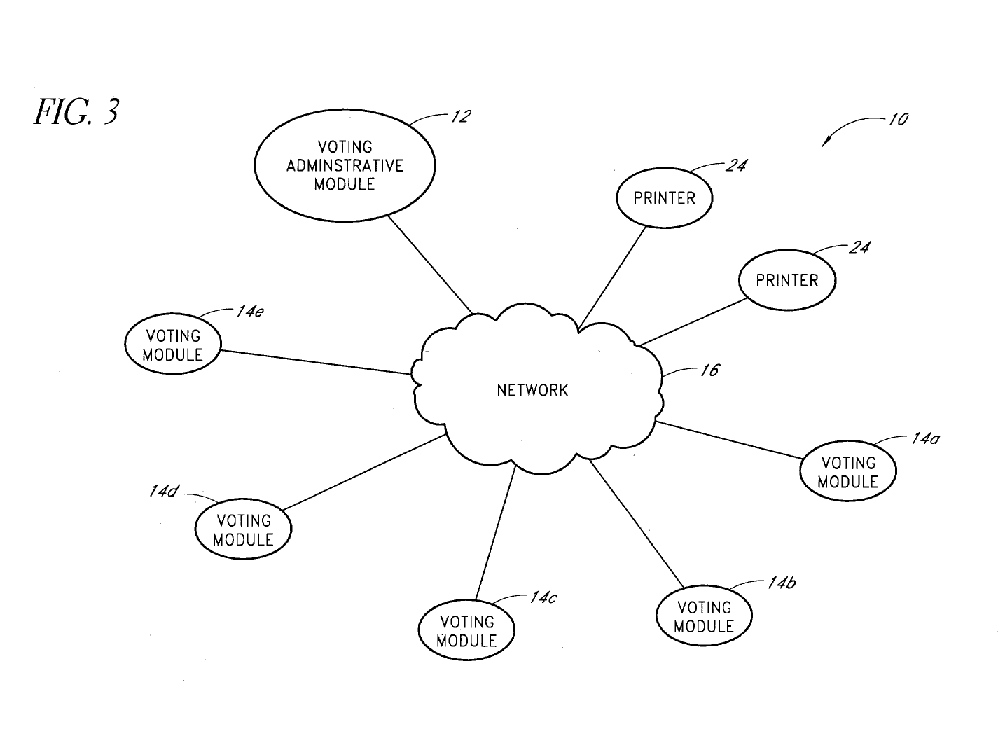

FIG. 3 illustrates a second preferred architecture of the electronic voting system 10. As shown in FIG. 3, instead of a dedicated ballot printer 74 per voting module 14, one or more shared printers 74 are connected to the network 16. The ballots are then printed on a network-attached printer 74 and picked up by the voter for review prior to being deposited in a ballot box by the voter. Thus, the second preferred architecture may advantageously utilize fewer printers 74.

Further to FIG. 2, each voting module 14 has a dedicated voting key reader 68 connected through, for example, a serial or Universal Serial Bus (“USB”) interface. The voting key reader 68 is capable of reading a voting key 90 inserted by an election official or a voter. The voting key 90 includes, for example, a smart card that contains voting information.

The voting key 90 preferably, has the following features. First, the voting key 90 permits a voter to vote a single time using the voting key 90. Second, the voting key 90 does not identify the voter. Third, the voting key 90 provides ballot logic control information to the voting module 14 application. Fourth, the voting key 90 acts as a security mechanism by ensuring that the voting key 90 is being used in the proper polling place. Fifth, the voting key 90 includes an indicator which indicates if the ballot cast by the voter should be flagged as a provisional ballot. Sixth, the voting key 90 may optionally contain a political party identifier for use in primary elections. Seventh, the voting key 90 includes a storage area where the voting module 14 application can write a ballot key associated with the ballot previously cast by the voter.

As discussed above, the voting key 90 advantageously precludes a voter to vote more than once using the voting key 90 at the polling place. Thus, preferably programmed on the voting key 90 is a VOTING_PERMISSION indicator flag that is initially set to “on” to allow the voter to vote at a voting module 14 and a POLLING_PLACE_ID identifier that is used by the voting module 14 to lookup the appropriate ballot for the corresponding polling place on the voting module 14. If the voter is casting a provisional ballot, then a PROVISIONAL_BALLOT indicator flag is set to “on” to indicate to the voting module 14 that the ballot cast by the voter should be marked as a provisional ballot and not included in the election tally until the voter's eligibility has been confirmed.

Further to FIG. 2, electronic storage module 20 of the voting administrative module 12 and the electronic storage module 78 of the voting module 14 store, for example, voting applications, voting information and databases. Preferably, a database on each voting module 14 contains the ballots cast by voters on that voting module 14. Optionally, the ballots contained in the database may be stored in an encrypted form. Furthermore, the electronic storage modules 20, 78 may include a standard database structure stored in a computer readable medium for facilitating electronic voting and counting comprising a table of candidate names and party affiliations, a table of election contests on the ballot, a table linking the election contest to the list of candidates running in the contest and a table of ballots that contains all ballots cast at the voting module 14.

Optionally, the electronic storage module 20 and the electronic storage module 78 may include additional ballot tables containing all of the ballots cast at the polling site. Each ballot table advantageously comprises a unique identifier (ballot key) for each ballot cast, an audit timestamp when a ballot was cast, an entry for each contest containing the candidate that the voter selected in the contest, a SPOILED_BALLOT indicator flag that indicates if the ballot has been spoiled and excluded from the final vote tally, and a PROVISIONAL_BALLOT indicator flag that indicates that the ballot should not be counted in the vote tally results until the eligibility of the voter who cast the ballot is confirmed. Once the voter eligibility has been confirmed, then the ballot can be included as part of the official vote tally. Optionally, the format of the ballot table may be the same on a voting module 14 and the voting administrative module 12.

Preferably, the voting module 14 and the voting administrative module 12 use an open source operating system, such as the Red Hat distribution of the open source Linux operating system running on standard Intel-based or Transmeta-based PC hardware. Additionally, the voting module 14 and voting administrative 12 module applications may be written in any computer programming language, such as Java using Sun's standard Java Developer's Kit and Java Virtual Machine. The underlying database utilized by these Java applications may be, for example, an industry standard relational database management system (e.g., MySQL, Oracle, or DB2).

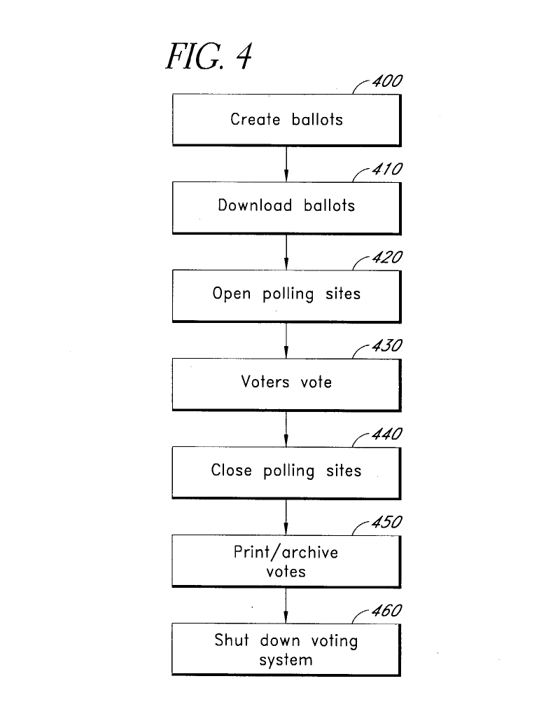

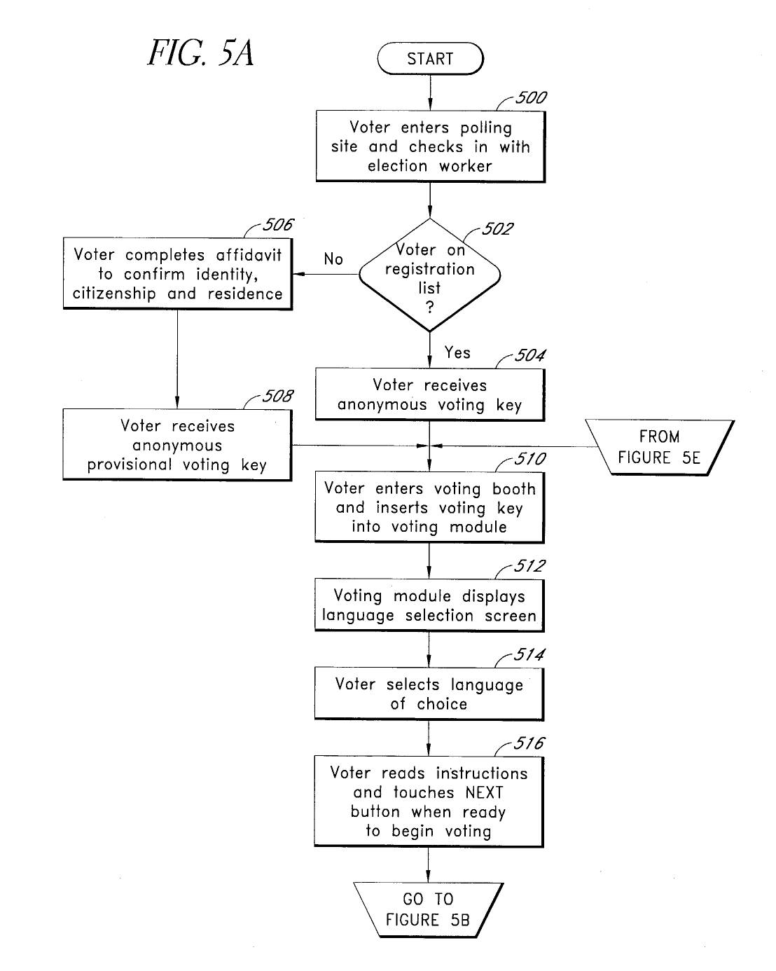

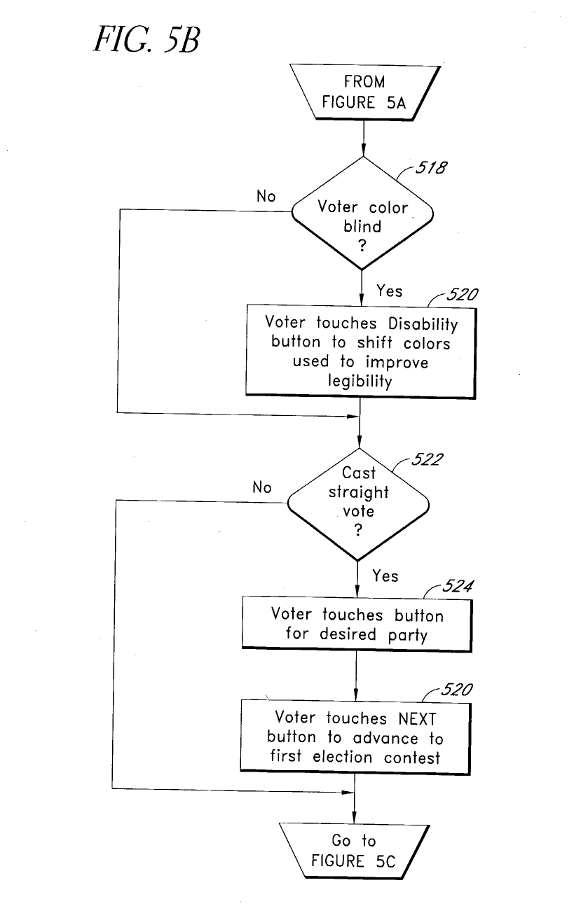

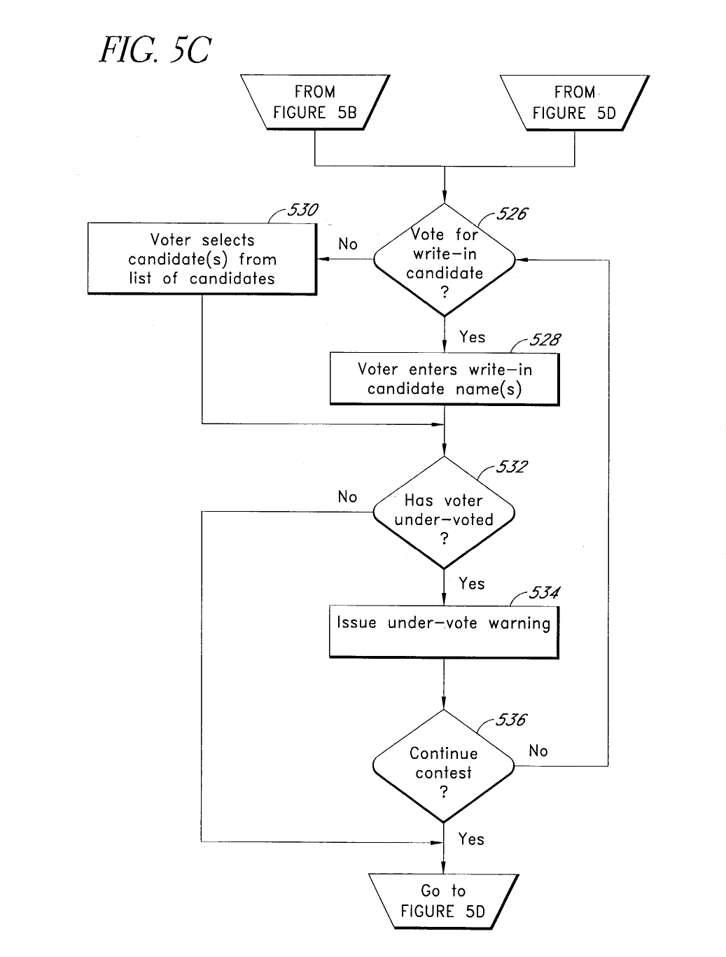

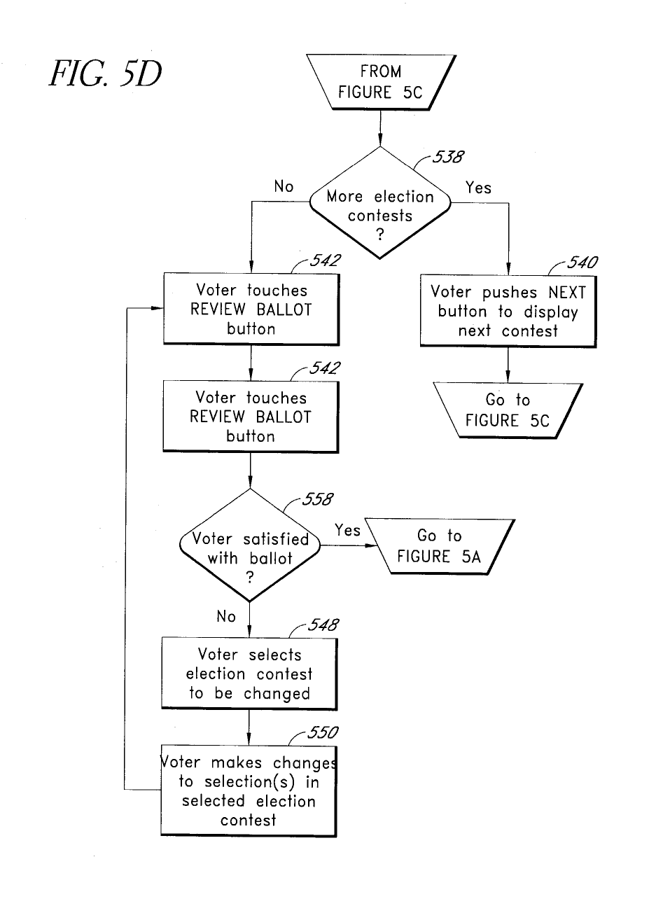

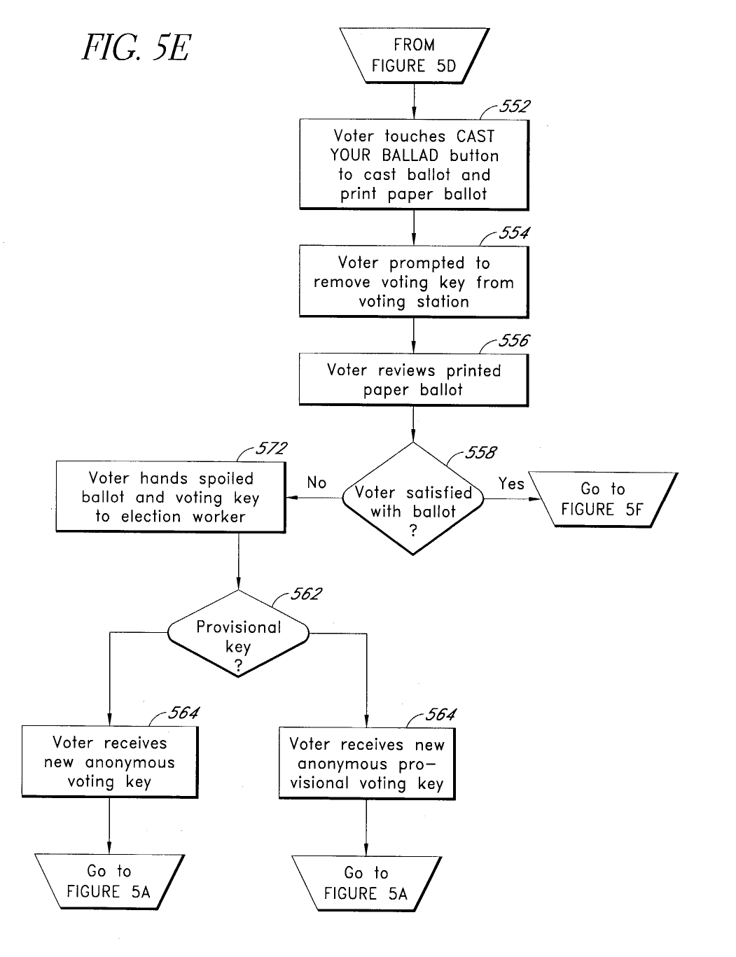

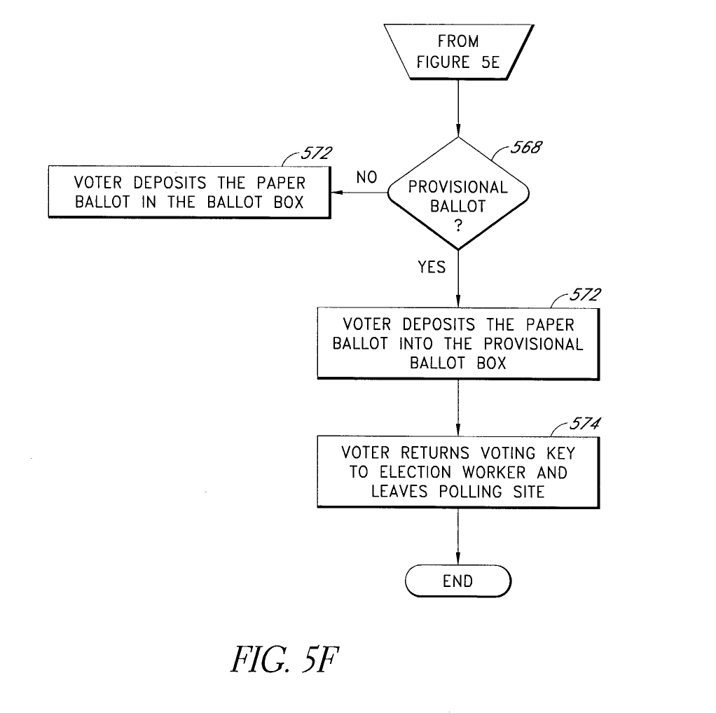

A general description of the a voting process using a preferred embodiment of the electronic voting system 10 is described with particular reference to FIG. 4. A more detailed explanation of a portion of voting process using the electronic voting system 10 will be described later with reference to FIGS. 5(A-F).

First, in a step 400, the voting process starts with the creation of ballots for every polling place in the county or state where the voting will be conducted. Ballots may be created with a polling place electronic voting system Ballot Creation Tool (“BCT”). In a preferred embodiment, the BCT is a Java application that guides an election official through the process of creating the ballot for each polling place. The BCT preferably uses an Extensible Markup Language (“XML”) Document Type Definition (“DTD”) to generate an XML document that contains the correct ballots for every polling place in the county or state. Advantageously, the BCT is also capable of creating multilingual ballots.

Each ballot includes information for facilitating the voting process. For example, information included in a ballot may be a date and a name of the election, a type of election contest (e.g., general election or primary election), a list of candidate names and party affiliations, a list of election contests to be included on the ballot, a list of candidates running in each election contest, a number of selections a voter is permitted to make for each contest, controls for how candidates are to be displayed for each contest, language selections supported by the ballot, a list of screens to be displayed, text that is to be displayed on each screen in all supported languages, active buttons on each screen, the order that screens should be displayed, and the initial screen to display.

Once the ballots for the polling sites are created using the BCT, the resulting XML documents are downloaded onto a write once/read-many times memory device and are certified as the official ballot to be used on election day. Advantageously, an XML parser on a voting module 14 may then parse the XML encoded ballot specification to generate the screens required for the voting application.

After the ballots are created, an election official downloads the appropriate ballot or ballots for the voting module 14 from the voting administrative module 12 in a step 410. In the step 410, the read-only memory device is inserted into the voting administrative module 12 and the ballots are copied to the voting administrative module 12. From the voting administrative module 12, the appropriate ballots for the polling place are downloaded to each voting module 14 connected to the voting administrative module 12 in a polling site.

The electronic voting system 10 is then accessed, or “opened”, at the polling site for voting by a local election official in a step 420. The process of opening each voting module 14 for voting preferably includes having the local election official utilize an administrative voting key with the voting administrative module 12 and issue a command to open each voting module 14 connected to the voting administrative module 12.

Next, in a step 430, the voters enter the polling site and check-in with the election officials manning the polling site. After an election official has authenticated a voter's identity and has confirmed that the voter is in the correct polling place, the voter is given a voting key 30 to enable the voter to vote once at a voting module 14 located in the polling place. The voter inserts the voting key 30 into the voting module 14 to begin the voting process. The voting module 14 then presents the voter an appropriate ballot. The voter then selects preferences on the touch screen display 26 of the voting module 14. After the voter has cast votes for each contest, the voter is prompted to confirm all selections prior to casting a ballot.

Once a voter has confirmed the voter's ballot, a unique identifier (“ballot key”) is generated, and together with the ballot, the unique identifier is recorded on the voting module 14. Optionally, a unique identifier is provided that does not identify the voter who cast the ballot. Further, once the ballot has been recorded on the voting module 14, the voting key 30 is disabled for advantageously preventing the voter from voting again.

Each ballot cast on each voting module 14 is transmitted to a voting administrative module 12 and stored in the electronic storage module 20. A physical copy of the ballot is also printed. Preferably, after the voter reviews the printed ballot, the voter deposits the printed ballot in the ballot box at the polling place and returns the voting key to an election official at the polling place. Optionally, a physical print copy of some or all of the ballots cast may be printed using either the printer 24 attached to the voting module 14, the printer 24 attached to the voting administrative module 12, or one or more printers 24 attached to the network 16.

The voting site is closed in a step 440. Advantageously, a polling site's electronic voting system 10 is capable of being disabled for voting by a single local election official. Preferably, the local election official inserts an administrative voting key into the voting administrative module 12 and issues a command to close (i.e., terminate the operation of,) each voting module 14 connected to the voting administrative module 12.

After the voting modules 14 at the polling site have been closed for voting, the votes cast on the voting modules are printed and archived in a step 450. Preferably, a tally report is generated from a database on each respective voting module 14. Advantageously, the tally report may include the number of ballots cast on the voting module 14 and the number of votes that each candidate received in each election contest.

Furthermore, the database of each voting module 14 and the voting administrative module 12 are archived. Preferably, the databases are archived by inserting a blank write-once/read-only media into a media-writer 34 of each voting module 14 and then selecting an archive function associated with the voting module 14. After the report has been printed and the database of the voting module 14 has been archived, the voting module 14 is shut down and powered off.

The voting administrative module 12 is then shut down in a step 460. The shut down process of the voting administrative module 12 preferably includes having the local election official insert or enter an administrative key or code into the voting administrative module 12. The election official then inserts a blank write-once media, such as a write-once compact disk, into the voting administrative module media-writer 22 and then selects an archive voting-database button to archive the voting administrative module database.

Furthermore, at the close of voting at the polling site, an authorized election official preferably prints a summarized report of the ballots cast at each of the voting modules 14. The report includes, for example, all the votes cast for each candidate in all election contests. In one embodiment, the recorded ballots from each of the voting modules 14 are also on write-once/read-many times electronic media for permanent storage. Optionally, these steps may also be performed on the voting administrative module 12 that contains the accumulated votes for all the voting modules 14 at the polling place. Consequently, the reports generated on the voting administrative module 12 may be advantageously cross-audited against the reports generated from the voting modules 14 to ensure the accuracy of the vote tally.

Optionally, the paper ballots may be printed after the close of the polling place. Following the close of voting at the polling place, an election official inserts the administrative key into the voting administrative module 12 and issues a command to initiate the printing of paper ballots for some or all of the ballots stored in the database on the voting administrative module 12. These printed ballots may be advantageously cross-referenced with the electronic ballots stored in the electronic storage modules 20, 78 for auditing the election results.

A ballot key associated with each ballot allows the official paper vote to be matched up against the two electronic ballots for advantageously locating any discrepancy within a short amount of time, should any discrepancy occur. In the event of a formal challenge of the voting results, the printed ballots can be easily and quickly recounted by machine, or readily hand-counted if need be.

Local voting regulations may determine if the electronic counts are reported as unofficial results before the paper ballots are machine counted. If required, paper ballots can be hand counted. Because the paper ballots have been prepared in a uniform and proper format with less human handling than pencil or punch card systems, the count can be conducted very rapidly. This method is advantageous because decisions about when to release vote totals to the media can be made entirely by election officials for reasons of public policy, rather than being dictated by the mechanics of counting.

A detailed explanation of operation of a preferred embodiment of the electronic voting system 10 will be described in further detail with reference to FIGS. 5A-5F. In particular, FIGS. 5A-5F describe in further detail the steps 430 through 450 of FIG. 4.

The operations illustrated in FIGS. 5A-5F are directed toward voting in a general election. However, the operation may be modified by those skilled in the art so that the system and method may be used in other types of elections, for example, an open blanket primary, an open standard primary with public declaration, an open standard primary with private choice, a modified closed primary, or a closed primary.

First, in a step 500, a potential voter proceeds to an election official to authenticate the voter's identity and to confirm that the voter is eligible to vote at the polling place. Next, in a decision step 502, if the voter is on the list of registered voters, then the Yes path is followed to a step 504, where the voter receives an anonymous voting key. The voting key preferably does not identify the voter so that the voter's choices will remain secret. However, if the voter is not on the list of registered voters, then the No path is followed to a step 506. In the step 506, the voter fills out an affidavit to confirm the voter's identity, citizenship and residence. After the voter completes the affidavit, the voter receives an anonymous provisional voting key 90 in a step 508.

The voter then enters a voting booth in a step 510. The voting booth includes a voting module 14. The voter inserts the voting key into the voting key reader 68 of the voting module 14. A voting module 14 procedure then ensures that the voter is allowed to vote by verifying that a VOTING_PERMISSION flag contained in the voting key 90 is set to ‘on’ and that a POLLING_PLACE_ID contained in the voting key 90 matches a polling place ID assigned to the voting module 14. If the VOTING_PERMISSION flag is not set to ‘on’ or the POLLING_PLACE_ID does not match that of the voting module 14, then the voting module 14 rejects the attempt of the voter to cast a ballot. The voting module 14 then displays a message to the voter indicating the problem (e.g., either disabled voting key or mismatch of polling place ID) and instructs the voter to remove the voting key 90 and return the voting key 90 to an election official and ask for further assistance.

Once the voting module 14 application has checked that the voting key 90 allows the voter to cast a ballot, a language selection screen is displayed on the touch screen 66 of display the voting module 14 in a step 512. The language display screen prompts the voter to select which of the supported languages to use during the voting process. The voter makes the selection by pressing a button corresponding to the selected language in a step 514. Advantageously, from that point forward, communication between the voter and the voting module 14 is done using the selected language.

Optionally, a language selection button may be displayed on the touch screen display 66 throughout the remainder of the voting process using the voting module 14. Consequently, a voter may advantageously switch languages at any point if, for example, the voter does not understand the current language being used by the voting module 14.

Next, in a step 516, the voting module 14 displays a voting instruction screen instructing the voter how to vote using the touch sensitive voting display screen 66. Once the voter has read the instructions, the voter proceeds to the next step by pressing the NEXT button.

In a step 518 and a step 520 (FIG. 5B), the electronic voting system and method advantageously accommodates for color-blind voters. In a decision step 518, if the voter is color-blind, the voter touches the “color-blind” button. The Yes path is then followed to a step 520 and the voting module 14 shifts the colors used to display the voting options to improve the legibility of the touch sensitive display screen 66 for the color-blind voter. After the step 520, the process proceeds to a step 522 where the voter begins voting.

Generally, once the voter has begun the voting process, the voting module 14 application reads a PRECINCT_ID from the voting key 90 to identify a correct ballot to display to the voter. The voting module 14 application, for example, uses an XML parser to parse the XML document and locate the appropriate ballot matching the PRECINCT_ID. The voting module 14 application then begins displaying the ballot on the touch screen display 66. Preferably, the display screen 66 displays the ballot to the voter one election contest at a time. Alternatively, the display screen 66 may display more than one election contest at the same time so that the voter does not need to touch the next button each time the voter makes an election contest selection. The voter then casts each vote by selecting his or her preference on the touch sensitive display screen 66.

In counties or states that allow a voter to choose a “not voting in this contest” selection a NOT VOTING IN THIS CONTEST button is optionally displayed automatically on each contest page throughout the voting process. Accordingly, the voter may deliberately optionally press the NOT VOTING IN THIS CONTEST button to indicate that the voter does not want to vote in this contest. Thus, by prompting the voter in under vote situations or providing the voter with a NOT VOTING IN THIS CONTEST selection, the electronic voting system 10 advantageously reduces the likelihood that a voter's intent is improperly conveyed.

In a decision step 522, the voter is prompted to select whether to cast a straight party vote. If the voter selects to cast a straight party vote, then the Yes path is followed to Step 524 where the voter selects the party that will receive the straight party vote. Furthermore, a voter can advantageously “cross-over” and vote for a candidate of a different party on a contest-by-contest basis. If the voter selects to not cast a straight party vote, then the No path is followed to a step 526 (FIG. 5C).

In the step 526, the voter is prompted to choose whether to vote for a write-in candidate. If the voter selects the write-in candidate option, then the Yes path is followed to a step 528 where the voter enters the write-in candidate's name. A voter may advantageously vote for write in candidates by entering the candidate's name using a keyboard displayed on the voting display screen, or if the voter is blind, the voter may enter the candidate's name using the external tactile keypad 80 to select the letters of the write-in candidate's name.

If the voter does not select the write-in candidate option, then the No path is followed to a step 530, where the voter is prompted to select a candidate from a list of candidates. In the step 530, the voter selects a candidate by pressing an area of the touch screen display 66 that corresponds to the desired candidate.

After the voter has finished writing in a candidate in the step 528 or has selected a candidate in the step 530, the electronic voting system proceeds to the “under-voting” detection feature in a decision step 532 and a step 534. First, in the decision step 532, the electronic voting system determines whether the voter has under voted by analyzing the number of votes the voter has cast in the election contest. If the electronic voting system determines that the voter has not under voted, then the system proceeds to a decision step 538 (FIG. 5D) via the No path. If the electronic voting system determines that the voter has under voted (i.e., has cast fewer votes than the voter is allowed to cast in the election contest), then the Yes path is followed and the electronic voting system issues an under-vote warning in the step 534. Thus, because a voter can skip an election contest, the electronic voting system 10 advantageously ensures that the voter intended to skip a voting contest through the use of the “under-voting” feature.

The voter is then prompted to decide whether to continue with the next contest in a decision step 536. If the voter selects not to continue with the next contest, then the No path is followed back to the step 526. If the voter selects to continue with the next contest, or if the electronic voting system 10 determines that the voter has not under voted in the step 532, then the process proceeds to the decision step 538.

In the decision step 538, the electronic voting system determines if there are more election contests. If there are more election contests, then the Yes path is followed to a step 540 where the voter is prompted to touch the Next button to display the next contest. After the Next button is pushed, the process returns to the decision step 526. However, if there are no more contests, then the No path is followed to a step 542.

After the voter has cast votes for each contest or touches the REVIEW BALLOT button in the step 542, a review ballot screen appears that displays the voter selections in all election contests. Based on the preference selected during ballot creation, the election contests on the review ballot screen are preferably displayed in the order the contests were defined as part of the ballot. Optionally, the election contests may instead be displayed in the order where all contests in which the voter has under voted are at the top of the list and where the contests in which the voter did vote are positioned lower in the list. However, further ballot display orders not discussed herein may also be used.

The voter then reviews the ballot selections for each contest in a step 544 and is then prompted to confirm the selections in a decision step 546. If the voter wants to change the selections in any contest, the voter presses the button assigned to the specific contest in a step 548. The voter then changes the selections in the selected contest in a step 550. Additionally, throughout the steps 548 and 550, the REVIEW BALLOT button is displayed. Thus, once the voter is finished updating the selections, the voter may press the REVIEW BALLOT button in the step 542 to advantageously return to the review ballot screen.

Once a voter is satisfied with the selections, the voter presses a CAST YOUR BALLOT button in a step 552 to officially cast the ballot. After the voter has pressed the CAST YOUR BALLOT button, the actions listed below occur, but not necessarily in the order presented below.

First, a ballot key is generated associated with the ballot the voter has just cast. The ballot key advantageously does not identify the voter, but is used to uniquely identify the ballot. Thus, the ballot key may be used to match the corresponding paper ballot with the voting key and the electronically stored ballot without identifying the voter.

Second, if the PROVISIONAL_BALLOT indicator flag on the voting key 90 is ‘on,’ then the voter's ballot is marked as a provisional ballot. The ballot key together with the voter's ballot, a timestamp when the ballot was cast, and a provisional ballot indicator are recorded in the database on the voting module 14. This is known as the BALLOT_RECORD.

Third, the VOTING_PERMISSION indicator flag on the voting key 90 is set to “off” to prevent the voter from using the voting key 90 to vote again. The ballot key is then recorded on the voting key 90 in the event that the voting key 90 must be used later to “spoil” the voter's electronic ballot.

Fourth, a tally table in the database on the voting module 14 is then updated to reflect the voter's selections on the ballot. This tally table may be used to advantageously crosscheck the official voting results.

Next, the BALLOT_RECORD is sent to the voting administrative module 12 on the network 16 connected to the voting module 14. When a BALLOT_RECORD is received on the voting administrative module 12, the BALLOT_RECORD is stored in the database on the voting administrative module 12, and the tally table in the database on the voting administrative module 12 is updated to reflect the voter's selections on the ballot just received.

Additionally, a public ballot counter included in the voting module 14 is incremented to reflect a confirmed ballot being cast on the voting module 14. The public ballot counter may be used to cross-audit how many voters used the electronic voting system 10.

The voter is instructed to remove the voting key 90 from the voting key reader 68 in a step 554. A paper ballot is then printed on the ballot printer 74 containing the ballot key identifier associated with the voter's ballot and the voter's selections in each of the election contests. After the paper ballot has been printed, the voter is instructed to review the paper ballot to ensure that the selections have been properly recorded in a step 556.

If, the voter in a decision step 558, indicates dissatisfaction with the ballot then the voting process proceeds via the No path to a step 560. Examples of when a voter is not satisfied with the ballot include instances where the voter's intent is not correctly reflected in the ballot, such as when the voter intended to cast a vote for a particular candidate, but the ballot reflects that the voter intended to cast a vote for a different candidate. Thus, the electronic voting system 10 has the advantage of allowing the voter to review the voting selections on a paper ballot before the voter finally officially casts the vote.

Further to the step 560, the voter goes to an election worker and instructs the election worker to spoil the ballot. At this point, the election worker takes the paper ballot and the voting key 90 from the voter and spoils the ballot. Preferably, the election worker spoils the ballot by depositing the paper ballot in a spoiled election box and uses the voter's voting key 90 to spoil the electronic ballot cast by the voter. The voting key 90 is inserted in the voting administrative module and the election worker spoils the electronic copy of the voter's ballot by advantageously using the unique ballot key identifier for the ballot stored on the voting key 90. Alternatively, the spoiled paper ballot may be destroyed, or handled in whatever matter is appropriate with local laws.

After the ballot is spoiled in the step 560, the voter receives a new anonymous voting key 90. First in a decision step 562, an election worker determines whether the voter receives a provisional voting key depending upon whether the voter is listed on the registration list. The voter receives a new provisional voting key in a step 566 or receives a regular voting key in a step 564. The voter then returns the voting booth and the electronic voting system reinstates the process in the step 510.

If in the decision step 558, the voter is satisfied with the ballot, then the voting process proceeds to a step 568 (FIG. 5E). In the decision step 568, the electronic voting system determines whether the voter's ballot is a provisional ballot.

If the ballot is a provisional ballot, then the Yes path is followed from the decision step 568 to a step 572 where the election worker at the polling place instructs the voter according to state election law and practice regarding the handling of the provisional ballot. The voter then deposits the paper ballot into the provisional ballot box, and the process proceeds to a step 574 wherein the voter gives the voting key 90 to an election worker and leaves the polling site. If, in the decision step 568, the ballot is not a provisional ballot, then the voter deposits the paper ballot in the ballot box in a step 570, and the process proceeds to the step 574.

Optionally, the electronic voting system 10 may also advantageously include several features that promote the use by handicapped and disabled voters and advantageously complies with the Americans with Disabilities Act. These features provide support, for example, for blind, color-blind, paraplegic and quadriplegic voters to be able to vote anonymously and unassisted.

A first feature includes a touch screen mounted in compliance with the Americans with Disabilities Act that allows wheelchair bound voters to touch the screen to cast their ballot. For example, the voting module 14 may advantageously be placed on a table or stand in a voting booth at a height in compliance with the American With Disabilities Act so that a wheelchair bound voter can reach the touch screen to vote.

Another feature, as described above in connection with FIG. 5B, advantageously accommodates color-blind voters. A color-blind voter may touch a button on the touch screen display 26 to change the colors used on the touch screen display 26 so that the ballot is more legible for a color-blind voter.

Another feature is the use of an external tactile keypad for the voter to use to make ballot selections and to navigate through the ballot selection process. The external tactile keypad has buttons with raised Braille lettering that allow blind voters to navigate the ballot, make selections, and cast ballots.

Another feature also accommodates, for example, blind voters. The electronic voting system 10 may optionally include audio headphones to enable the voting module 14 to verbally read the ballot and the voter's ballot selections to the voter. The electronic voting system 10 may also be configured to advantageously read the ballot in different languages.

Another feature includes incorporating voice recognition technology into the electronic voting system 10 for aiding, for example, blind and quadriplegic voters to cast ballots using the audio headphones and a microphone. Advantageously, the electronic voting system may be configured so that the voice recognition technology understands different languages. Examples of voice recognition systems that may be used are described in U.S. Pat. No. 5,068,900 and U.S. Pat. No. 5,003,603.

In one embodiment, a voting module 14 using voice recognition is configured with a limited, pre-defined set of recognizable voice commands and responses (in multiple languages if required) that allow the disabled voter to navigate the election contests on the ballot, select a candidate or candidates from a list of candidates for an election contest, review their ballot selections, and cast their ballot. Voice commands may include, for example, REVIEW BALLOT, CAST BALLOT, SELECT CANDIDATE, NEXT SELECTION, PREVIOUS SELECTION, SELECT PARTY, NEXT CONTEST, PREVIOUS CONTEST, YES, NO, and CONTINUE.

Although described above in connection with particular embodiments of the present invention, it should be understood the descriptions of the embodiments are illustrative of the invention and are not intended to be limiting. Various modifications and applications may occur to those skilled in the art without departing from the true spirit and scope of the invention.

What is claimed is:

1. An electronic voting system that produces an official voter verifiable paper ballot, comprising:
a voting administrative module having a first network interface capable of connectivity to a network, said voting administrative module capable of sending and receiving voting information over said network and electronically tallying and storing the voting information;
at least one voting module having a second network interface for connectivity to said network, said voting module configured to receive votes cast by a voter and configured to send voting information to said voting administrative module, said voting module including:
a processor that analyzes voting information;
an electronic storage device that stores voting information;
voting key reader adapted to analyze a voting key, said voting system enabling a voter to cast votes on said voting system only when said voting key is proper; and
a touch screen display that displays voting options to a voter and that allows the voter to select the voting options by touching said touch screen display;
and
a printer adapted to receive voting information and print a ballot that includes the votes cast by the voter, said printer capable of printing the ballot using optical recognition characters, the ballot capable of being reviewed by the voter to verify the votes.

2. The voting system of claim 1, wherein said voting system generates and saves electronic ballots that correspond to the ballots printed by the printer.

3. The voting system of claim 2, wherein said voting system is configured to generate unique ballot identifiers for each ballot cast, said voting system configured to assign said unique identifiers to said electronic ballots and to print said unique identifiers on said paper ballots, wherein said unique identifiers may used to link said paper ballots to said electronic ballots.

4. The voting system of claim 1, wherein said voting key reader comprises a smart card reader.

5. The voting system of claim 1, wherein said voting key includes a smart card.

6. The voting system of claim 1, wherein said voting module includes a headphone and a microphone, said headphone adapted to provide a voter with voting instructions and voting options, said microphone adapted to permit a voter to provide voice commands to said voting module for making voting selections.

7. The voting system of claim 1, wherein said voting module includes voice recognition capabilities.

8. The voting system of claim 1, wherein said touch screen display accommodates color-blind voters.

9. The voting system of claim 1, wherein said voting administrative module further includes a media-writer that archives voting information on an electronic storage media.

10. The voting system of claim 1, wherein said printer prints ballots having optical recognition characters so that the ballots can be optically scanned by a machine.

11. The voting system of claim 1, wherein said voting module further includes an external tactile keypad.

12. An electronic voting module that produces an official voter verifiable ballot, comprising:
a processor that analyzes voting information;
an electronic storage device that stores voting information;
a network interface that provides connectivity to a central administrative computer;
a touch screen display that displays voting options to a voter and allows the voter to cast votes by touching said touch screen display; and
a printer adapted to generate paper ballots that indicate voter's selections, the paper ballots capable of being reviewed by the voter.

13. The electronic voting module of claim 12, wherein the paper ballots are capable of being an official ballot.

14. The voting module of claim 12, wherein said voting key reader comprises a smart card reader.

15. The voting module of claim 12, wherein said voting key includes a smart card.

16. The voting module of claim 12, wherein said voting module includes a headphone and a microphone, said headphone adapted to provide a voter with voting instructions and voting options, said microphone adapted to permit a voter to provide voice commands to said voting module for making voting selections.

17. The voting module of claim 12, wherein said voting module includes voice recognition capabilities.

18. The voting module of claim 12, wherein said touch screen display accommodates color-blind voters.

19. The voting system of claim 12, wherein said printer prints ballots having optical recognition characters so that the ballots can be optically scanned by a device.

20. The voting module of claim 12, further including an external tactile keypad.

21. An electronic voting module that produces a voter verifiable paper ballot, comprising:
a touch screen display to display voting options to a voter and to allow the voter to select a voting option by pressing said touch screen display; and
a printer to generate a paper ballot reflecting the voter's selections, the ballot capable of being reviewed by the voter.

22. The voting module of claim 21, wherein said voting module generates and saves electronic ballots that correspond to the ballots printed by the printer.

23. The voting module of claim 21, wherein said voting module generates a unique ballot identifier that links said electronic ballots to said paper ballots.

24. The voting module of claim 21, wherein said voting key includes a smart card.

25. The voting module of claim 21, wherein said voting module includes a headphone and a microphone, said headphone adapted to provide a voter with voting instructions and voting options, said microphone adapted to permit a voter to provide voice commands to said voting module for making voting selections.

26. The voting module of claim 21, wherein said voting module includes voice recognition capabilities.

27. The voting module of claim 21, wherein said touch screen display accommodates color blind voters.

28. The voting module of claim 21, wherein said administrative voting module further includes a media-writer for archiving voting information on an electronic storage media.

29. The voting module of claim 21, wherein said printer prints ballots having optical recognition characters so that the ballots are capable of being optically scanned by a scanning device.

30. The voting module of claim 21, wherein said voting module further includes an external tactile keypad.

31. An electronic voting system that produces a voter verifiable paper ballot, comprising:
an voting administrative module connected to a network, said voting administrative module sending and receiving voting information over the network and processing and storing the voting information;
a plurality of voting modules connected to said network to receive votes cast by a voter;
a touch screen included in said voting module to display voting options and to allow a voter to select voting options by pressing said touch screen display; and
at least one printer connected to said network, said printer generating paper ballots that indicate the voter's selections, the ballots capable of being reviewed by the voter.

32. The voting system of claim 31, wherein said printer is directly connected to said voting module.

33. The voting system of claim 31, wherein said voting system comprises at least two voting modules and at least two printers, wherein each printer is directly connected to one of said voting modules.

34. The voting system of claim 31, wherein said voting system comprises at least two voting modules and at least one printer, wherein said at least one printer is directly connected to said network.

35. The voting system of claim 31, wherein said voting system generates and saves electronic ballots that correspond to the ballots printed by the printer.

36. The voting system of claim 31, wherein said voting key reader comprises a smart card reader.

37. The voting system of claim 31, wherein said voting key includes a smart card.

38. The voting system of claim 31, wherein said voting module includes a headphone and a microphone, said headphone adapted to provide a voter with voting instructions and voting options, said microphone adapted to permit a voter to provide voice commands to said voting module for making voting selections.

39. The voting system of claim 31, wherein said voting module includes voice recognition capabilities.

40. The voting system of claim 31, wherein said touch screen display accommodates color blind voters.

41. The voting system of claim 31, wherein said voting administrative module further includes a media-writer to archive voting information on a removable electronic storage media.

42. The voting system of claim 41, wherein the removable electronic storage media is a compact disk.

43. The voting system of claim 41, wherein the removable electronic storage media is a removable flash memory.

44. The voting system of claim 31, wherein said printer prints ballots having optical recognition characters so that the ballots can be optically scanned by a machine.

45. The voting system of claim 31, wherein said voting module further includes an external tactile keypad.

46. A method of voting with an electronic voting system that generates a voter verifiable paper ballot, comprising:
providing a voting key to enable a voter to vote on a voting module;
inserting said voting key in a voting key reader of an electronic voting module;
analyzing said voting key to verify that the voter has permission to vote; and
if said voter has permission to vote, then:
displaying voting options on a touch screen display of the electronic voting module;
selecting the voting options by touching said touch screen display; and
generating a voter verifiable paper ballot, said voter verifiable ballot including at least some of the voting options that the voter selected.

47. The method of voting of claim 46, wherein generating said paper ballot includes generating said paper ballot after the voter has finished voting.

48. The method of voting of claim 46, wherein generating said paper ballot includes generating said paper ballot after the close of a polling site.

49. The method of voting of claim 46, further including opening a polling site and closing a polling site, said opening of said polling site including setting up said electronic voting system.

50. The method of voting of claim 46, further including issuing an under vote warning when a voter has not voted in a contest.

51. The method of voting of claim 46, further including prompting the voter to select whether to cast a straight party vote.

52. The method of voting of claim 46, further including selecting a language from a list of languages by touching the touch screen.

53. The method of voting of claim 46, further including selecting a color-blind accommodation option.

54. The method of voting of claim 46, further including casting a vote for a write-in candidate by using a keyboard displayed on the touch screen display.

55. The method of voting of claim 46, further including displaying the ballot cast by the voter on the touch screen display.

56. A method of spoiling a ballot using an electronic voting system having an voting administrative module and a plurality of voting modules connected to a network, comprising:
assigning an anonymous ballot identifier to a voter's electronic ballot;
printing a paper ballot that is associated to the voter's electronic ballot, said paper ballot including the ballot identifier printed on the paper ballot;
extracting the voter's electronic ballot stored in an electronic database that is associated with the ballot by inputting the unique identifier printed on the paper ballot into a computer; and
marking said electronic ballot as spoiled.

57. An electronic voting system that produces a voter verifiable paper ballot comprising:
a voting module that receives votes cast by a voter, that saves an electronic ballot in an electronic storage module, and that produces a unique ballot identifier corresponding to each saved electronic ballot; and
a printer that produces a paper ballot that is reviewable by a voter, wherein said paper ballot includes the unique identifier corresponding to the saved electronic ballot so that an election worker may associate the electronic ballot with the paper ballot.
